(19) United States
(12) Patent Application Publication
(10) Pub. No.: US 2023/0241916 A1
(43) Pub. Date: Aug. 3, 2023

(54) Mat Traction System

(71) Applicant: Spartan Mat LLC, Gilbert, AZ (US)

(72) Inventors: Jeff Juergens, Youngsvile, LA (US); Craig Kunar, Livonia, MI (US); Caleb Delp, Rockledge, FL (US)

(21) Appl. No.: 18/104,334

(22) Filed: Feb. 1, 2023

Related U.S. Application Data
(60) Provisional application No. 63/305,553, filed on Feb. 1, 2022.

(51) Int. Cl. B60B 39/12

(52) U.S. Cl. CPC B60B 39/12; B60B 2900/721

(57) ABSTRACT

A traction system for increasing traction on a mat can comprise a first surface and a second surface adapted for a vehicle wheel or pedestrian foot to contact wherein the first surface comprises a plurality of first traction elements extending from the first surface. The first traction elements and the second traction elements can be attached to each other. The first traction elements can have a set pattern extending across the first surface. The second traction elements can comprise one or more side walls that are arranged as a crosshatch pattern that substantially diamond shape in the middle of the crosshatch pattern each wall having substantially the same height.

### CROSS REFERENCE TO RELATED APPLICATIONS

This application claims benefit from currently pending U.S. Provisional Application No. 63/305,553 titled “Improved Mat Traction System” and having a filing date of Feb. 1, 2022, all of which is incorporated by reference herein.

### TECHNICAL FIELD

The present technology relates to a traction system, more particularly a traction system that includes multiple traction elements.

### BACKGROUND

Conventionally mats system are typically used in construction sites, oil and drilling operations and other industrial sites. These types of areas are in wet areas such as bogs, wetlands, or fens where construction vehicles can become stuck without a solid, clean driving surface. Since, the areas are wet or can become wet or boggy during operations a construction mat with good traction for the vehicles is needed. Generally, a mat traction system includes a plurality of raised elements that extend from the mat’s surface to ensure traction while driving on the mats.

Typically, mat systems have raised elements to provide traction for the tread portion of the tire on a vehicle. Mats in the prior art generally have a tops side and a bottom side wherein the traction elements extend from both sides in various set patterns. The traction or raised elements provide both a traction element on the top side of the track for vehicles that are driving over the top side while providing a traction element on the bottom side that grips the ground or surface that the mat is placed on. As vehicles drive over the mat the vehicle’s tires grip onto the traction elements which helps the vehicle’s tires to not slip, and the mat does not move on the surface which could be muddy, wet ground where extra traction is needed. In addition, they also provide traction benefit for individuals walking over the mats. The traction elements that these mats usually have are a gripping means such as treads, cleats, undulations, spikes, or the like that grip the wet ground, snow or ice.

One of the major problems with traction elements on mats is that the treads, cleats, undulations, or traction elements are designed only to grip the ground and tire, but fail to take into account that mud, water and debris that will fill in gaps between these elements thus making the traction element useless. Further, these raised elements for traction purposes are made from the same composite materials as the mat base and therefore are more slippery compared to other materials such as sandpaper or other traction materials. In addition, if the traction elements on the bottom surface are large and the top of the traction elements are flat it essentially creates a flat, slippery surface that does not provide any traction at all.

Current mats such as that provided in U.S. Pat. No. 6,511,257 provide a surface with raised elements that allow the tire to grip onto however, the mat’s treads are flat or rounded and provide a smooth surface for the vehicles tire to spin on. The conventional mat system comprises traction promoting elements such as raised strips extending outwardly from the planar surface. This type of mat only provides limited traction due to the surface still being slick on both sides of the mat surface and the raised strips being distributed throughout the mat with only small area between the traction elements. In addition, these elements eventually wear out under the pressure of the vehicle and only provide limited traction on the mat surface once worn out causing an even slicker surface for vehicles and pedestrians.

It would be advantageous to provide a traction mat system that provides extra traction elements on the other (on top of) traction elements that adds extra traction for the vehicles to grip onto, and that allows construction vehicles etc. to safely and more efficiently drive over composite mats.

### SUMMARY

In embodiments a traction system for increasing traction on a mat can comprise a first surface and a second surface adapted for a vehicle wheel or pedestrian foot to contact wherein the first surface comprises a plurality of first traction elements extending from the first surface. The first traction element can comprise at least two end walls, and at least two side walls that can substantially form a traction surface from the ends and the side walls. A plurality of second traction elements can extend from the traction surface wherein the second traction elements can extend from the traction surface wherein the second traction elements substantially tappers as they extend from the traction surface.

The first traction elements and the second traction elements can be attached to each other. The first traction elements can have a set pattern extending across the first surface. An orientation of the first traction element can be different from an orientation of the second traction element. The second traction elements can further comprise one or more side walls wherein the side walls are arranged to form a substantially diamond shape (or cross-hatch of some similar version) having the substantially the same height. At least two ends can have at least a first end and a second end. The second traction element diamond shape can taper into a point, or a blunt end. The substrate can be rocks, snow, dirt, mud, or any combination thereof. The second traction element can be the shape of diamond, square, rectangular, circular, oval, or hexagonal. The second surface is a mirror image of the first surface.

A method for manufacturing a traction system to add traction to a vehicle, comprising the steps of creating an upper mold and lower mold. Forming a first traction element and a second traction element within at least one of the upper mold or the lower mold. Heating a material that is placed onto the lower mold wherein the lower mold is brought in position with the upper mold. Compressing the upper mold down onto the lower mold forming the upper side of the mat. Repeating the process to form the lower side of the mat. Welding the upper side and the lower side together. The upper side and the lower side are brought together and welded wherein the the upper side and lower side can be ultrasonically welded together.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the. Absent such clear statements of intent to apply a “special” definition, it is the inventor’s intent and desire that the simple, plain, and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112 (f). Thus, the use of the words “function,” “means” or “step” in the Detailed Description or Description of the Drawings or claims is not intended to somehow indicate a desire to invoke the special provisions of 35 U.S.C. § 112 (f), to define the invention. To the contrary, if the provisions of 35 U.S.C. § 112 (f) are sought to be invoked to define the inventions, the claims will specifically and expressly state the exact phrases “means for” or “step for”, and will also recite the word “function” (i.e., will state “means for performing the function of molding a ..., without also reciting in such phrases any structure, material or act in support of the function. Thus, even when the claims recite a “means for performing the function of molding a ...., step for performing the function of molding a ...,” if the claims also recite any structure, material or acts in support of that means or step, or that perform the recited function, then it is the clear intention of the inventors not to invoke the provisions of 35 U.S.C. § 112 (f). Moreover, even if the provisions of 35 U.S.C. § 112 (f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

Additional features and advantages of the present specification will become apparent to those skilled in the art upon consideration of the following detailed description of the illustrative embodiment exemplifying the best mode of carrying out the invention as presently perceived.

### BRIEF DESCRIPTION OF THE DRAWINGS

These and other features, aspects, and advantages of the present specification will become better understood with regard to the following description, appended claims, and accompanying drawings where:

FIG. 1 is an isometric view of an improved mat traction system thereof in accordance to one, or more embodiments;

FIG. 2 is a top view of an improved mat traction system thereof in accordance to one, or more embodiments;

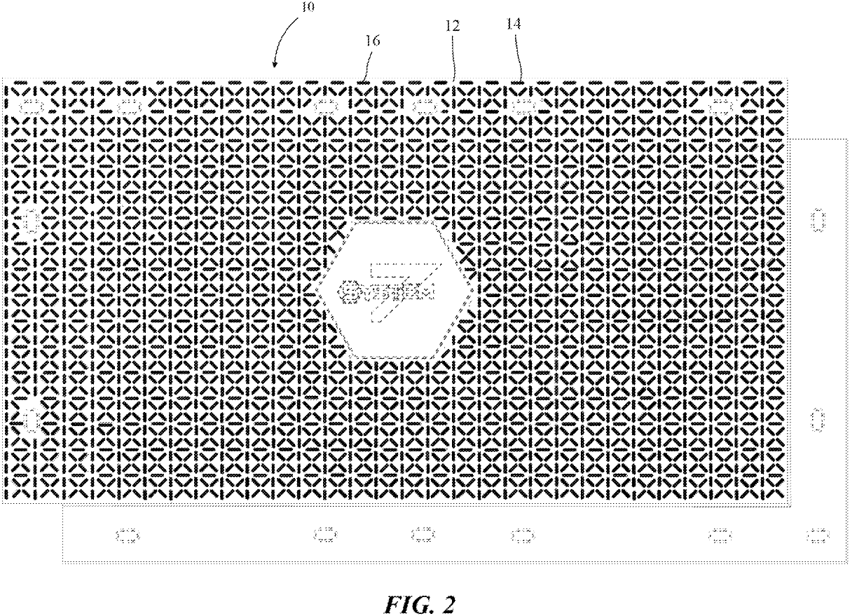

FIG. 3 is a bottom view of an improved mat traction system thereof in accordance to one, or more embodiments;

FIG. 4 is a closeup top view of an improved mat traction system thereof in accordance to one, or more embodiments;

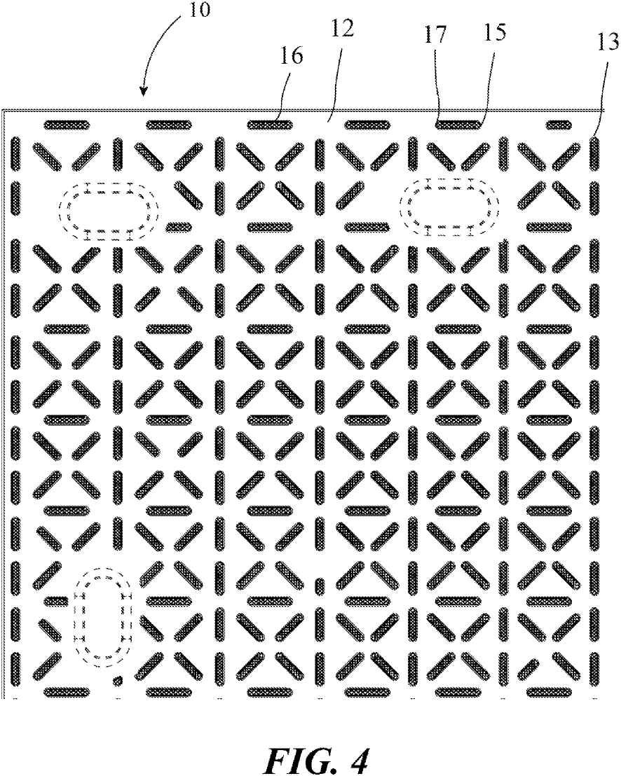

FIG. 5 is a side and closeup view of an improved mat traction system thereof in accordance to one, or more embodiments; and

FIG. 6 is an isometric closeup view of an improved mat traction system thereof in accordance to one, or more embodiments.

Elements and acts in the figures are illustrated for simplicity and have not necessarily been rendered according to any particular sequence or embodiment.

### DETAILED DESCRIPTION

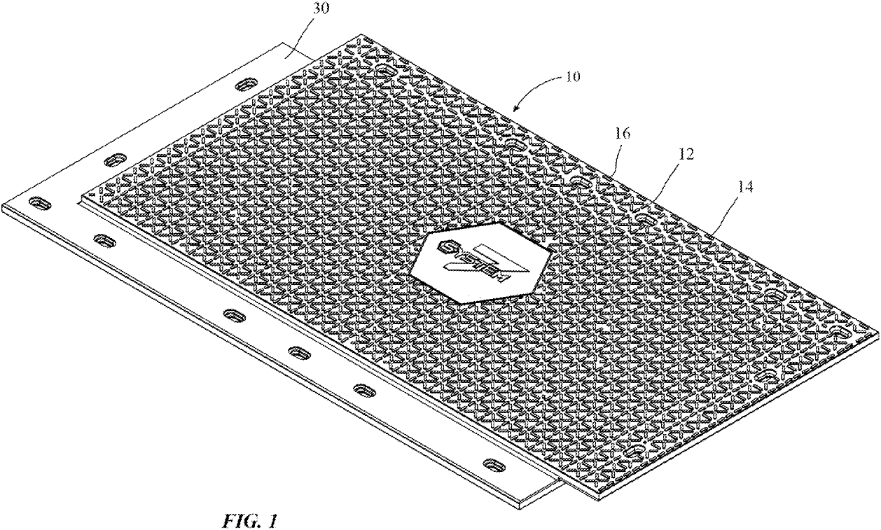

Referring initially to FIGS. 1 - 6, an embodiment of an improved traction system for increasing traction on a mat for vehicles and pedestrians is shown generally at 10. A traction system 10 can comprise a first surface 12 and a second surface 40 adapted for at least one vehicle wheel or substrate surface to come into contact with. The first surface 12 comprises a plurality of first traction elements 16 extending from the first surface at a distance having at least two ends 13 wherein in the preferred embodiment the two ends can be a first end 15, a second end 17 and at least two walls 21 forming the traction surface 14. The first traction element 16 can be oriented in a set pattern as shown in FIG. 1 or it can be a random pattern extending across the first surface 12. The first end 15 and the second end 17 can be such as, for example, radiused, squared, blocked or the like. The first traction element 16 can extend at a distance of such as, for example 0.05 to 0.50 inches and still more preferably from 0.1 to 0.325 inches and most preferred at least 0.19 inches from the first surface 12.

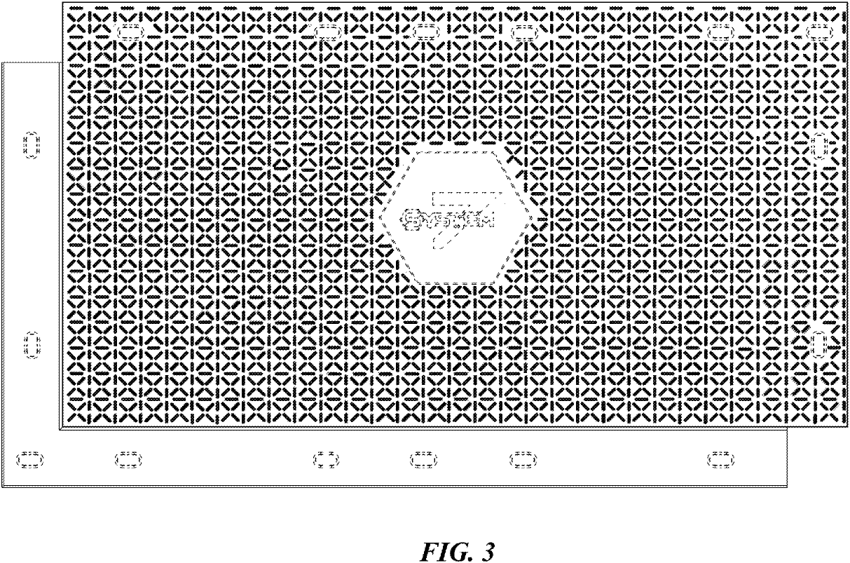

The walls 21 and the ends 13 can extend from the first surface 12 wherein the walls and ends form the first traction surface 16 at the top of the first traction element 16. The first traction element 16 can be shape as shown in FIG. 3 or it can be such as, for example, rectangular, circular, hexagonal, octagonal, triangular, oval or the like in shape each having a traction surface 14. In certain embodiments the first traction element 16 can taper from the first surface 12 to the traction surface 14 wherein the first traction element base can be larger than its top. In other embodiments the first traction elements 16 can be omitted.

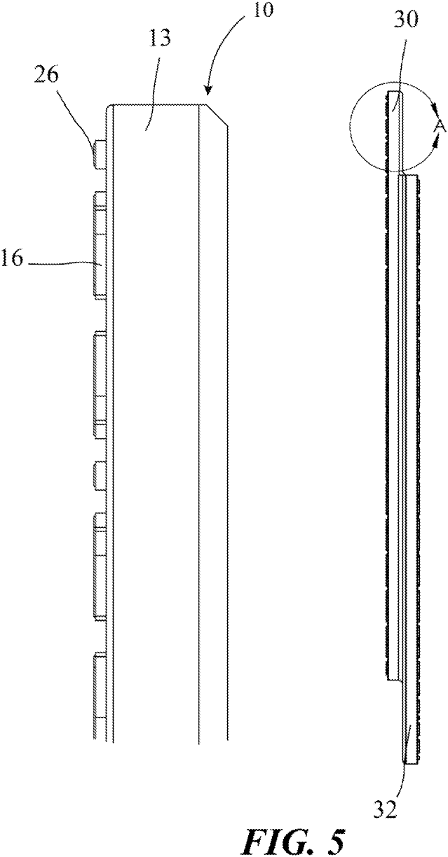

In embodiments, the traction surface 14 can have a plurality of second traction elements 26 wherein the second traction elements can extend from the traction surface to a distance from the second traction element. The second traction elements 26 can taper into such as, for example, a point, a blunt surface, a flat surface, or the like or the second traction element can extend straight from the first traction element 16. The second traction elements 26 can have at least two walls extending from the first traction surface 14. The second traction elements 26 can have at least one or more side walls that can be arranged as a crosshatch pattern that substantially diamond shape in the middle of the crosshatch pattern each wall having substantially the same height as shown in FIGS. 5 - 6, or it can be, such as, for example, a cross pattern, a hatch pattern, a wave pattern, maze pattern, parallel pattern, octagonal pattern, hexagonal pattern, rectangular pattern, contour pattern, or the like. The second traction element 26 can extend at a distance of such as, for example 0.01 to 0.250 inches and still more preferably from 0.2 to 0.1 inches and most preferred at least 0.03 inches from the traction surface 14 as shown in FIG. 5. In other embodiments the second traction elements 26 can have at least one or more side walls that can be arranged as a varying pattern wherein each wall can vary in height creating an antiskid or zeroskid element on the first traction element.

The second traction element 26 can be formed from the first traction element 16 or it can be added onto the first traction element as a separate body. The second traction element 26 can be the same material as the first traction element 16 wherein the material can be, such as, for example, high-density polyethylene, ultra-high molecular weight polyethylene, low density polyethylene, linear low-density polyethylene, cross-linked polyethylene, or the like. In certain embodiments the second traction element 26 can be a metal, such as, for example, stainless steel, carbon steel, aluminum, or the like wherein the second traction element can be integrated within the first traction element 16 such that during the manufacturing process the second traction element can be placed in the mold and the first traction element can encapsulate at least a portion of the second traction element when formed. In other embodiments the second traction element 26 can be omitted.

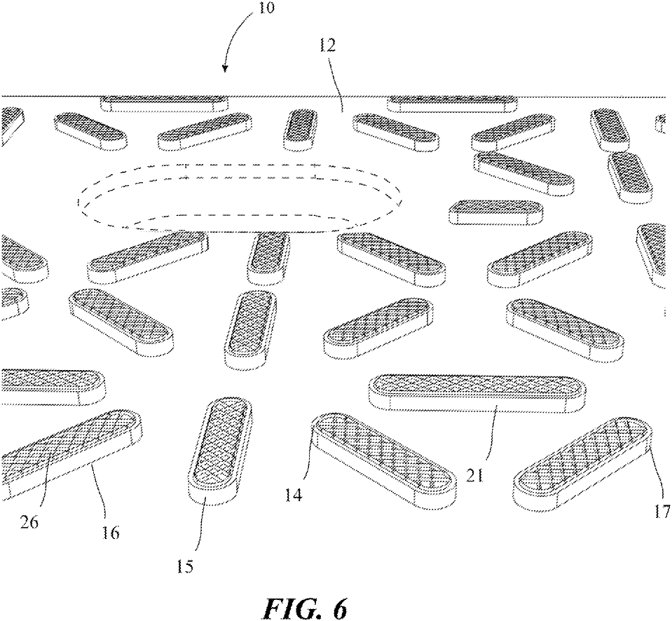

In embodiments, the first surface 12 and the second surface 14 can be mirror images of each, mirrored images and flipped, opposite hand version of each other, or the like. The first surface 12 and the second surface 14 can be on an upper mat 30 and a lower mat 32 wherein the upper mat and the lower mat can be attached to each other by such as, for example, sonically welded, laser welding, infrared welding, spin welding or the like. In other embodiments, the first surface 12 and the second surface 14 can be opposite patterns from each other and/or can vary from each other wherein in the preferred embodiment the pattern can be as shown in FIG. 6 or it can vary in thickness, or in depth, in height, or can be such as, for example, triangular, octagonal, hexagonal, circular, or the like.

A method for manufacturing an improved traction system on a mat surface, comprising the steps of creating an upper mold and lower mold wherein the upper and lower mold comprises the general shape of an upper mat and a lower mat wherein the upper mat can comprise of the first surface and the lower mat can comprise of the second surface. The mold can further comprise of the first traction elements and the second traction elements. A heated material can be placed onto the lower mold wherein the lower mold is brought in position with the upper mold. The upper mold is compressed down onto the lower mold forming the upper side of the mat. The process can be repeated to form the lower side of the mat. The upper side and the lower side are then brought together and weld wherein they can be weld by such as, for example, sonically welded, laser welding, infrared welding, spin welding or the like.

In other embodiments, the second traction element can be placed into the mold and then the material is placed onto the lower mold and the upper mold can compress the lower mold forming the second traction elements partially into the first traction element.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular methodology, protocol, and/or reagent, etc., described herein. As such, various modifications or changes to or alternative configurations of the disclosed subject matter can be made in accordance with the teachings herein without departing from the spirit of the present specification. Lastly, the terminology used herein is for the purpose of describing particular embodiments only and is not intended to limit the scope of the present disclosure, which is defined solely by the claims. Accordingly, embodiments of the present disclosure are not limited to those precisely as shown and described.

Certain embodiments are described herein, including the best mode known to the inventors for carrying out the methods and devices described herein. Of course, variations on these described embodiments will become apparent to those of ordinary skill in the art upon reading the foregoing description. Accordingly, this disclosure includes all modifications and equivalents of the subject matter recited in the claims appended hereto as permitted by applicable law. Moreover, any combination of the above-described embodiments in all possible variations thereof is encompassed by the disclosure unless otherwise indicated herein or otherwise clearly contradicted by context.

What is claimed is:

1. A traction system for increasing traction on a mat comprising:
a first surface and a second surface adapted for a vehicle wheel to contact wherein the first surface comprises:
a plurality of first traction elements extending from the first surface, the first traction element comprising at least one end, and at least two side walls that substantially form a traction surface from the ends and the side walls; and
a plurality of second traction elements extending from the traction surface wherein the second traction elements extend from the traction surface wherein the second traction elements substantially tapper as they extend from the traction surface.

2. The traction system of claim 1, wherein the first traction elements and the second traction elements are attached to each other.

3. The traction system of claim 1, wherein the first traction elements have a set pattern or an extending across the first surface.

4. The traction system of claim 1, wherein an orientation of the first traction element is different from an orientation of the second traction element.

5. The traction system of claim 1, wherein the second traction elements comprise one or more side walls that are arranged as a crosshatch pattern that substantially diamond shape in the middle of the crosshatch pattern each wall having substantially the same height.

6. The traction system of claim 1, wherein the at least two ends has at least a first end and a second end wherein the first end and the second end are radiused.

7. The traction system of claim 5, wherein each diamond shape tapers into a point, or a blunt end, or sharp surface.

8. The traction system of claim 5, wherein the substrate is rocks, snow, dirt, mud, or any combination thereof.

9. The traction system of claim 1, wherein the second traction element can be the shape of square, rectangular, circular, oval, or hexagonal.

10. The traction system of claim 2, wherein the second surface is a mirror image of the first surface.

11. A method for manufacturing a traction system to add traction to a vehicle, comprising the steps of:
creating an upper mold and lower mold;
forming a first traction element and a second traction element within at least one of the upper mold or the lower mold;
heating a material that is placed onto the lower mold wherein the lower mold is brought in position with the upper mold;
compressing the upper mold down onto the lower mold forming the upper side of the mat;
repeating the process to form the lower side of the mat; and
welding the upper side and the lower side together.

12. The method of manufacturing a traction system of claim 11, wherein the upper side and the lower side are brought together and welded.

13. The method of manufacturing a traction system of claim 12, wherein the upper side and lower side are ultrasonically welded together.
